(19) United States
(12) Patent Application Publication
(10) Pub. No.: US 2007/0216063 A1
(43) Pub. Date: Sep. 20, 2007

(54) Handling System for an Injection Molding Machine and Method for Inserting an Application In the Injection Mold

(76) Inventor: Kurt Knopfler, Munchen (DE)

Correspondence Address: KNOBBE MARTENS OLSON & BEAR LLP, 2040 MAIN STREET, FOURTEENTH FLOOR, IRVINE, CA, 92614, US

(21) Appl. No.: 10/563,783

(22) PCT Filed: Jul. 12, 2004
(86) PCT No.: PCT/EP04/07687

§ 371 Date: Apr. 10, 2007

(30) Foreign Application Priority Data
Jul. 11, 2003 (DE) 103 31 519.5

(51) Int. Cl. B29C 45/14

(52) U.S. Cl. 264/275; 425/289

(57) ABSTRACT

A handling system for an injection molding machine is presented wherein an application, for example a label, is inserted in the mold cavity (105) of an injection molding tool (104) before injection molding, when for example a beaker having the label (1) on the outer circumference is fabricated by injection molding, wherein a preform means (8) for the label (1) is provided outside the injection molding tool, has a feeder means (3, 4) for the label and a preform (5) into which the label is introduced by the feeder means, and is thus preformed to the shape in which it is to be inserted in the injection mold (105), and a transfer means (302) removes the preformed label from the preform (5) and delivers it to the injection mold (105), wherein the preform (5) is decouplable from the feeder means (3, 4) and moveable into a position different from it.

The invention relates to a handling system for an injection molding machine wherein an application, such as a label, is inserted in the mold cavity of the injection molding tool before injection molding, if for example a beaker having the label on the outer circumference is to be formed by injection molding. Further, the invention relates to a method for inserting in the injection mold an application, such as a label, adapted to the shape of the injection-molded article.

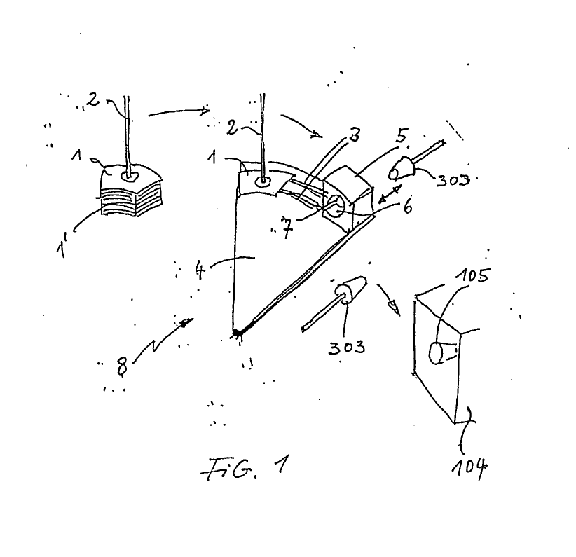

To insert a label in the injection mold in which a beaker having the label on the outer circumference is to be manufactured by injection molding, a preform means is provided consisting of a feeder means and a preform. FIG. 1 shows schematically such a preform means, wherein firstly a label 1 is picked up by a for example vacuum-applied gripper 2 from a pile of labels 1′ and is transferred by the gripper 2 in the direction of the arrow to a preform means 8 represented as a sector-shaped plate 4, on which arc-shaped guide carriages 3 are formed, in which grippers (not shown) applicable by vacuum are displaceably guided to take the label 1 from the gripper 2 and transfer it to a preform 5 whose preform cavity 6 corresponds to the mold cavity 105 of the injection molding tool 104. The preform 5 is provided adjacent the guide carriages 3 with a slit 7 extending in the axial direction of the preform cavity 6, through which slit the label is inserted in the preform cavity 6 by laying itself along the truncated cone-shaped inner circumference wall. As soon as the label is positioned on the inner circumference of the preform cavity 6, a truncated cone-shaped transfer tool 303 is inserted into the preform cavity 6, whereupon by vacuum application of the transfer tool 303 the label 1 adheres to its circumference and is transferred into the mold cavity 105 of the injection molding tool 104. Bores and channels of the transfer tool 303 for vacuum application are not shown in FIG. 1.

The preform means 8 is represented in FIG. 1 as a unit of the feeder means, consisting of the plate 4 having the guide carriages 3, and the preform 5. Here, admittedly a quick phase sequence can be obtained when feeding to one single injection mold 105, because when inserting the label by means of the transfer means 303 into the injection mold 105 a further label can already be preformed in the preform 5; however, for an injection molding machine having a plurality of injection molds 105 in the injection molding tool there results a more bulky construction with a large space requirement.

The invention is based on the object of specifying a method and an apparatus by which preformed applications for an injection molding machine having a large number of injection molds, can be transferred quickly and simply into the injection molds.

This object is solved according to the invention by the features in claims 1 and 4. Because the preform is decouplable from the feeder means and moveable into a position different from it, more possibilities result for the design of the handling system especially for a stack tool in an injection molding machine wherein at least two separating planes of the injection molding tool exist, each having a plurality of mold cavities or injection molds.

Examples of the invention are explained in more detail with reference to the drawings, in which

FIG. 1 shows a preform means for explaining the preform process of an application such as a label,

FIG. 2 shows a plan view of an injection molding machine having a handling system,

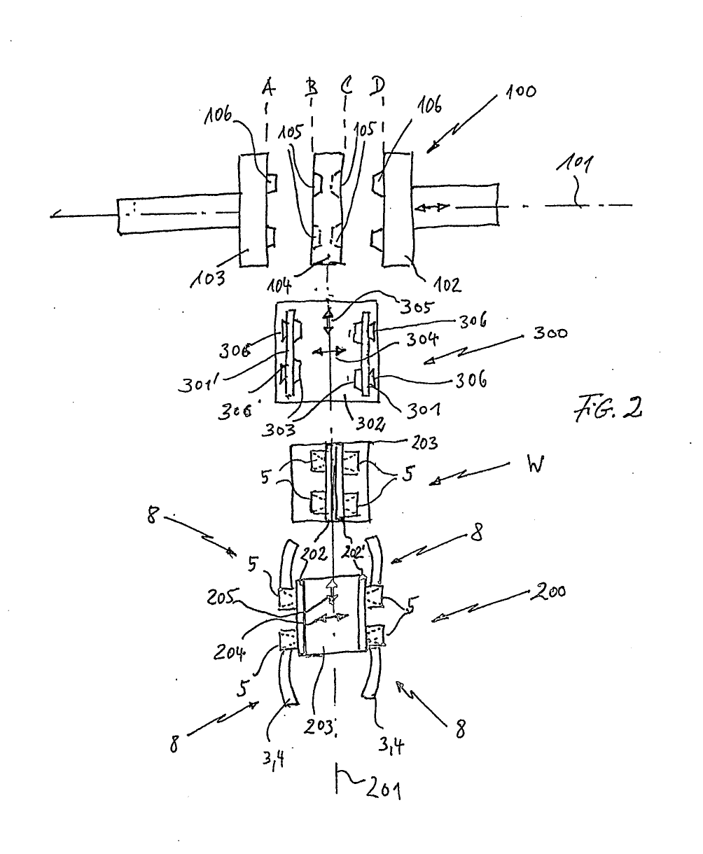

FIG. 3 shows a side view of the injection molding tool of the injection molding machine in the feeding direction having the transfer carriage arranged in front of it,

FIG. 4 shows a transfer means for the preforms in a view from below in FIG. 2,

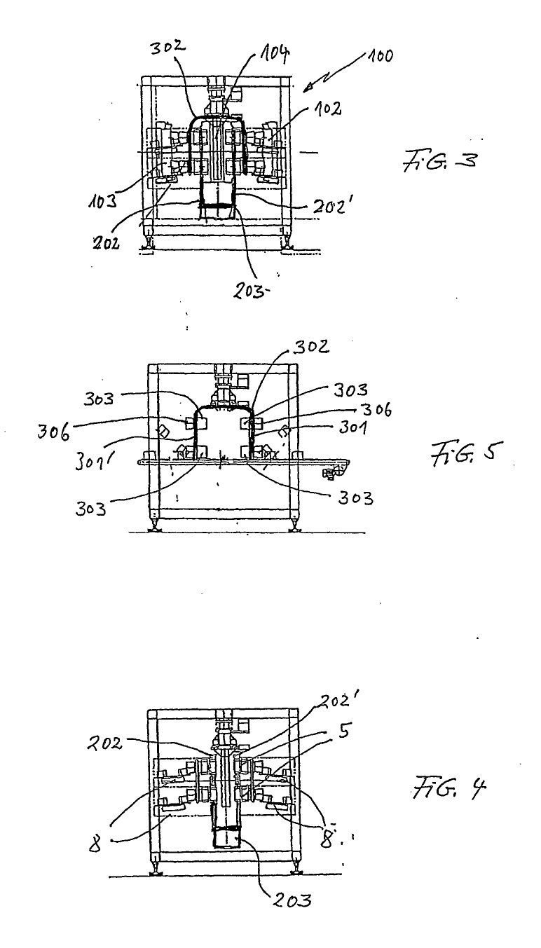

FIG. 5 shows a stack gripper in the view corresponding to FIG. 4,

FIG. 6 shows a schematic view of a couplable and decouplable core,

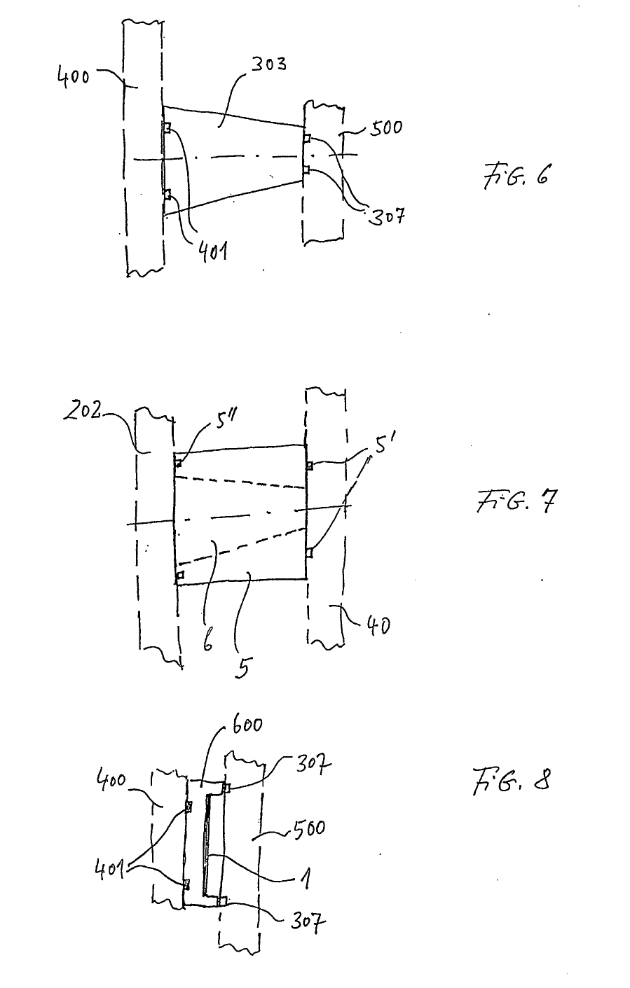

FIG. 7 shows a schematic view of a couplable and decouplable preform,

FIG. 8 shows another embodiment of a couplable and decouplable carrier element,

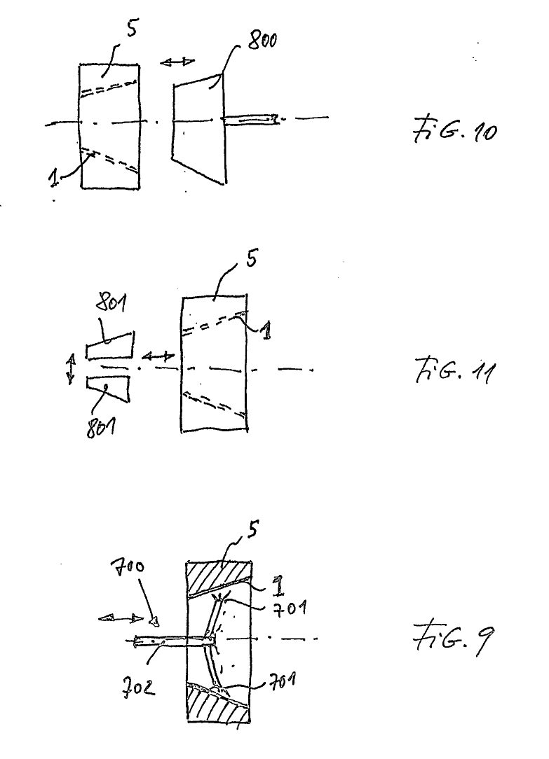

FIG. 9 shows a sectional view of a preform having blast nozzles,

FIG. 10 shows a schematic representation of a preform having an insertable supporting core, and

FIG. 11 shows a preform having a supporting core formed from individual segments.

FIG. 2 shows a schematic plan view of an injection molding machine 100 having a longitudinal axis 101, along which a movable element 102 is moveable in the direction of a stationary element 103 and away from this, as indicated by a double-headed arrow. Between the two elements 102 and 103, a stack tool 104 is arranged on both whose sides B and C injection molds 105 are formed, in which for example beakers are formed by injection molding. On the front ends A and D of the two elements 102 and 103, cores 106 are mounted and on closing of the injection molding tool these engage in the injection molds 105 to form a mold cavity corresponding to the beaker to be fabricated. The injection molding tool has two separating planes between A and B and between C and D.

200 designates a preform station wherein in the embodiment shown four preform units 8 exist in the way given in FIG. 1, wherein however the preforms 5 of these four preform means 8 are mounted on vertical transfer arms 202 and 202′ of a transfer carriage 203 which is moveable along an axis 201 transverse to the longitudinal axis 101 of the injection molding machine 100 to a delivery station 300. The transfer arms 202 and 202′ are moveable transverse to the moving direction 201 along the arrow 204 on the transfer carriage 203. In the position in the preform station 200, the two transfer arms 202, 202′ have been displaced apart so that the preforms 5 mounted on them can each receive a label fed along the guide carriages 3, 4. After receiving a label, the two transfer arms 202, 202′ are displaced together, whereupon the transfer carriage 203 is moved along the arrow 205 to the delivery station 300, as shown at W.

At each of the preform units 8, a revolver-like means can be provided by which the phase sequence of the label delivery to the preforms 5 can be increased.

The transfer carriage 203, shown at W on its path of displacement, moves with the transfer arms 202, 202′, which have been displaced together, between vertical inserter arms 301, 301′ of a stack gripper 2. On the two inner sides of the inserter arms 301 and 301′ cores 303 are mounted corresponding to the transfer tool 303 in FIG. 1. As soon as the transfer carriage 203 is positioned between the inserter arms 301, the transfer arms 202 are displaced apart so that the cores 303 engage in the preforms 5 and take up the pre-rolled labels inside them. The cores 303 are for example provided with channels and bores (not shown) on the circumference, so that by vacuum application and, if necessary, also by electrostatic charging from inside or outside, the label can be taken up from the preform 5 onto a core 303 and held fixedly upon it.

On the outer sides of the stack gripper 302, removal grippers 306 are provided by which finished injection-molded articles are removed from sides A and D of the injection molding tool.

Instead of a displacing-apart of the transfer arms 202, the inserter arms 301 of the stack gripper 302 can also be moved along the arrow 304 towards one another to take up the labels, and then after taking them up move apart from one another again.

The stack gripper 302 is then moved from the intermediate station 300 along the arrow 305 into the separating planes of the opened injection molding tool. In this position of the stack gripper 302 between the elements of the injection molding tool, the inserter arms 301 are moved towards one another along the arrow 304, so that the cores 303 and the label rolled up thereon are introduced into the mold cavities 105 of the stack tool 104.

After the introduction of the truncated cone-shaped cores 303 into the correspondingly shaped mold cavities 105, the labels are held in the mold cavities 105 by electrostatic charging from inside or outside, while simultaneously vacuum application and if necessary the electrostatic charge of the cores, if this is provided, is released, due to which the label is delivered to or laid in the injection molding tool or the injection mold 105 under electrostatic conditions. The inserter arms 301 which have been moved apart are moved out of the mold cavities 105, and after removal of the finished injection-molded parts the stack gripper 302 is moved out of the injection molding tool along the arrow 305 into the delivery station 300. Meanwhile the injection molding tool is closed and the injection molding process is started.

During the feeding of a label from the delivery station 300 into the injection molding tool, at the preform station 200 further labels can already be inserted in the preforms 5 and these can be moved by the transfer carriage 203 into a position W, from which they can be inserted between the inserter arms 301 of the stack gripper 302 after it has been moved back into the intermediate station 300.

Position W in FIG. 2 can coincide with the delivery station 300 so that the transfer carriage 203 is already in a standby position in the intermediate station 300 when the stack gripper 302 is displaced back out of the injection molding tool, so that taking-up of the labels from the transfer carriage 203 onto the stack gripper can take place immediately.

A significant advantage of the handling system described is that extremely short cycle rates can be run because the stack gripper 302 can remain in the position 300 for taking up labels or must not be moved additionally, wherein the finished injection-molded parts can be removed simultaneously from both outer sides of the stack grippers, as is also illustrated in FIG. 5.

The described embodiment of a handling system having a preform station 200 at which the preform 5 for a label is mechanically decouplable from the feeding means 3, 4, can also be provided advantageously in an injection molding machine having only one separating plane, because the phase sequence of the injection molding machine can be increased with regard to the transferring of a pre-rolled label from the preform station 200 directly between the mold halves of the injection molding tool. In the same way, more than two separating planes can also be provided on the injection molding tool, wherein the number of transfer arms 202 and inserter arms 301 is correspondingly increased.

FIG. 3 shows a side view of the injection molding machine 100 with the stack gripper 302 moved between the opened mold, halves and the transfer carriage arranged in front of it, wherein they are formed U-shaped and arranged facing towards one another.

FIG. 4 shows a view of the preform station 200 with the transfer carriage 203 between the preform means 8, wherein the preform means are arranged superposed in two levels so that in the arrangement shown in FIG. 2 of four preform means 8 in one level, altogether eight preform means 8 result in the preform station 200. In FIG. 3, correspondingly, two rows of mold cavities are shown one over the other.

FIG. 5 shows the stack gripper 302 in a view along the axis 201, wherein superposed cores 303 are provided in two levels for receiving the labels and for transferring them into the mold cavities 105. On the outsides of the inserter arms 301, removal grippers 306 are arranged, by which the stack gripper 302 can take up finished injection-molded parts or beakers simultaneously from levels A and D and transfer them out of the injection molding tool for example into position 300, from which they are taken by a means (not shown) from the removal grippers 306 as part of the inserter and removal arms 301 of the stack gripper 302 and transferred for example to a transporting device.

Further, the transfer carriage 203 can perform a taking-over function, for example to take up the finished injection-molded parts from the removal grippers 306 of the stack gripper. Such an embodiment is especially expedient if, by means of the transfer carriage 203, only labels are fed to the stack gripper, which labels are to be applied to a beaker cover or lid to be fabricated by injection molding. In this case, preforming in position 200 is omitted, wherein reception of the flat labels takes place at position 200 and these are delivered to the stack gripper 302 at position 300. In this way, too, an operative decoupling of steps takes place to increase the cycle rate of the injection molding machine.

According to a further embodiment of the invention, the cores 303 can be mounted mechanically couplable and decouplable for example on a gripper arm 400, so that the cores 303 can be coupled to an element 500 of an intermediate, taking up or buffer station. Here, a label can be held on the core 303 by an electrostatic charge. It is also possible to provide vacuum application of the core 303 at the gripper 400 or at the element 500 of another station.

In such an embodiment, the cores 303 are moved between individual stations, wherein due to the couplability and decouplability or due to transference of the cores 303 into receiving means, operative steps of the label standby station 200, the label taking up station, the transfer station and of other elements for the insertion and removal processes can run decoupled, so that the phase sequence of the injection molding machine can be further increased. Due to the decouplable and couplable cores 303 a decoupling of the cycle rate, and thus a time-non-critical running sequence of the operative steps of the individual elements of the handling system, is possible. This also applies to carrier elements instead of cores 303, which can for example be embodied as receiver discs for receiving and transferring a label to be applied to a cover or lid to be injection molded. FIG. 8 shows an embodiment of such a receiver disc 600 for a label 1.

The coupling and decoupling of the cores 303 can take place in various ways, Seen schematically in FIG. 6, pins 401 are provided on the gripper 400 and engage in corresponding bores of the core 303. Correspondingly, pins 307 can also be provided on the core 303 which engage in corresponding bores in the element 500. However, other joining means can also be provided, for example by magnets, vacuum application or the like.

While in the embodiment according to FIG. 2 the preform 5 is decoupled from the label feeder means 8 to increase the cycle rate of the injection molding machine as a whole, by decoupling the cores 303 or the preforms 5 themselves from the inserter arms 301 or transfer arms 202 shown in FIG. 2, a further overlapping of the individual sequences of the handling system can be provided, which leads to a further increase in the cycle rate of the injection molding machine.

FIG. 7 shows schematically a preform 5 which is releasably joined by means of a schematically indicated releasable joining means 5′ to an element 40 of the feeder means 3, 4, wherein simultaneously a releasable joint 5″ is provided to for example a transfer arm 202, so that the preform 5 can also be handled independently of the course of a preform process and of a removing process of a label by a core 303 from the preform 5 and the individual operative steps of the handling system can be further decoupled timewise.

The cores 303 or preforms 5 to be coupled or decoupled can also be mounted on rotating and pivoting units or indexing units. For coupling and decoupling, groove and key technology or the like can be used.

Instead of the described embodiment for fabricating a beaker, container or bucket on whose circumference a label is applied during injection molding, other injection-molded articles can also be provided with a corresponding application, for example flat injection-molded articles such as covers, CD boxes and the like. For a flat injection-molded article, such as a lid, instead of the cores 303 a corresponding carrier is provided for the label, bearing the label on its front end.

Different variations of the described embodiment are possible. For example, the transfer carriage 203 can be moveable into two or more positions, according to the individual operative steps provided in the handling system. Further, the horizontal moveability of the transfer carriage 203 and of the stack gripper 302 is only an example. A vertical path of movement 201 relative to the injection molding machine is also possible.

Further, the transfer carriage 203 having the transfer arms 202 can be formed in two parts and moved by two separate guide units. The embodiment can also be provided for an injection molding tool having only one single separating plane.

Instead of the only schematically shown stack gripper 302, a tri- or multi-axial robot can be provided which moves into the injection molding tool. Cartesian robots or articulated-arm robots can be provided.

According to an advantageous embodiment, the stack gripper 302 is used not only for inserting the labels in the injection mold 105, but also for removing the finished injection-molded article. Here, additional means can be provided on the stack gripper 302 for removing the finished injection-molded article, such as the removal grippers indicated by 306 in FIG. 5.

In the described embodiment of the injection molding machine, the labels are inserted on sides B and C of the stack tool 104 and the finished products are removed from separating planes A and D. It is also possible to provide corresponding mold cavities 105 on sides A and D, wherein then for example the cores 303 are positioned on the outsides of the inserter arms 301. The finished injection-molded parts are then removed from separating planes B and C.

Further, the preform means 8 can be embodied in a different way than the one shown in FIG. 1.

Especially for large-area labels and for labels for beakers or containers having a large diameter, it is advantageous if in the area of the preform station 200 a supporting means is provided for the label to be formed, which prevents a falling-in or detaching of the label during and after insertion.

FIG. 9 shows a section through a preform 5 on whose inner circumference a label 1 is inserted. A blast nozzle unit 700 is inserted in the preform 5 in the direction of the arrow and on its circumference blast nozzles 701 are radially arranged through which air is blown in the direction of the inner circumference of the preform 5, so that the label 1 is held in abutment until a suction means (not shown) provided at the preform 5 holds the label 1. Hereby, a falling-in of the label during the preform process is prevented. 702 designates a carrier which can be moved in and out in the axial direction and carries on the circumference the blast nozzles 701 which can be extendable. Their flow direction can be designed to be adjustable according to the embodiment of the inner circumference of the preform 5. This blowing means 700 is moved out of the preform as soon as the preform 5 is moved with the transfer carriage 203 for example into position W in FIG. 2. Here, the blowing means 700 can be arranged stationarily, because the preform 5 is moved with the transfer arms 202 relative to the blowing means 700. In the same way, the blowing means itself can be displaceable relative to the preform 5.

FIG. 10 shows a supporting core 800 which can be inserted in the preform 5 instead of a blowing means 700, to support the label 1 in the preform until the suction means in the preform 5 holds the label. Between the inner circumference of the preform 5 and the supporting core 800 a gap is formed in which the label 1 is arranged. This gap can for example be smaller than 2 mm.

FIG. 11 shows a supporting core composed of individual segments 801, wherein the segments are moveable radially relative to one another. In such an embodiment the supporting core can be inserted from the side of the preform 5 having a smaller inner diameter, but also alternatively from the side having a larger diameter, while the segments 801 are moved together, whereupon after insertion the segments 801 are displaced apart in the circumferential direction to support the label 1 in the preform 5.

Such a supporting means according to FIGS. 9 to 11 can also be provided in a preform means according to FIG. 1. It is not limited to use in a device according to FIG. 2.

1. Handling system for an injection molding machine wherein an application, for example a label, is inserted in the mold cavity of an injection molding tool before injection molding, when for example a beaker having the label on the outer circumference is fabricated by injection molding,
wherein a preforming apparatus for the label is provided outside the injection molding tool, has a feeder for the label and a preform into which the label is introduced by the feeder, and is thus preformed to the shape in which it is to be inserted in the injection mold, and
a transfer apparatus removes the preformed label from the preform and delivers it to the injection mold,
wherein the preform is decouplable from the feeder and moveable into a position different from it.

2. Handling system according to claim 1, wherein a transfer carriage is provided with at least one transfer arm on which the preform is mounted, and the transfer carriage is moveable into a delivery station in which a core of a stack gripper engages into the preform for transferring the preformed label, whereupon the stack gripper is moveable into the opened injection molding tool to transfer the preformed label to the injection mold.

3. Handling system according to claim 2, wherein on the stack gripper a core is provided which engages in the preform and takes up the preformed label.

4. Handling system according to claim 3, wherein by means of removal grippers mounted on the stack gripper finished injection-molded parts can be removed from the injection molding tool.

5. Handling system according to claim 2, wherein an injection molding tool is provided with to separating planes, the transfer carriage has at least two transfer arms moveable relative to one another, and the stack gripper in turn has at least two inserter arms moveable relative to one another.

6. Handling system according to claim 1, wherein the preform is mounted decouplably and couplably on the transfer arm or a corresponding element of a transfer apparatus.

7. Handling system according to claim 1, wherein the core is mounted decouplably and couplably on the stack gripper or another element of the handling system.

8. Method for inserting an application in the injection mold of an injection molding machine,
wherein the application is preformed in a preforming apparatus into the form in which it is to be inserted in the injection mold,
whereupon a preform with the preformed application is decoupled from the preforming apparatus and transferred to a delivery station, in which the preformed label is removed from the preform and subsequently transferred to the injection molding tool, whereupon the preformed label is inserted in the injection mold.

9. Preforming apparatus for an application to be applied to an injection-molded article, wherein a support is insertable into a preform and supports the application on the inner circumference of the preform until a holding mechanism provided on the preform takes over the holding of the label in the preform.
